(19) United States
(12) Patent Application Publication
(10) Pub. No.: US 2010/0266397 A1
(43) Pub. Date: Oct. 21, 2010

(54) LIGHTWEIGHT BLOWER

(75) Inventors: John Allen, Texarkana, TX (US); Bob Samuelson, Nashville, AR (US); Andrew Curtis, Texarkana, TX (US)

Correspondence Address: HOUSTON OFFICE OF;NOVAK DRUCE AND QUIGG LLP, 1000 LOUISIANA STREET, FIFTY-THIRD FLOOR, HOUSTON, TX, 77002, US

(73) Assignee: HUSQVARNA CONSUMER OUTDOOR PRODUCTS N.A., INC., Augusta, GA (US)

(21) Appl. No.: 12/747,610

(22) PCT Filed: Dec. 11, 2008
(86) PCT No.: PCT/US08/86454

§ 371 Date: Jun. 11, 2010

Related U.S. Application Data
(60) Provisional application No. 61/012,865, filed on Dec. 11, 2007.

(51) Int. Cl. F04D 29/54; B23P 17/04

(52) U.S. Cl. 415/208.1; 29/428

(57) ABSTRACT

Blowing devices (100) have many uses; for example, they can be used to dry, cool, clean, or move objects. These functions are often performed by human beings with limited carrying capacity and endurance; therefore, a lightweight blower (100) is desired to perform the above tasks more easily. In accordance with the example uses, the present disclosure includes a lightweight blower (100) having an upper scroll (11), a lower scroll (10), and a joint (15) where the two scrolls (10, 11) are welded together to form a strong, lightweight joint (15).

### CROSS-REFERENCE TO RELATED APPLICATION

The present application claims the benefit of U.S. Provisional Patent Application 61/012,865, filed on Dec. 11, 2007. Said application is incorporated herein by reference in its entirety.

### FIELD

The present disclosure relates generally to leaf blowers, and more particularly to the assembly of such blowers.

### BACKGROUND

Handheld power tools, such as leaf blowers, blower/vacs, line trimmers, chain saws, edgers, and the like are used more and more for different kinds of work. For example, leaf blowers are an effective and time saving tool for cleaning large areas such as parking places, pavements, lawns and footpaths. Leaf blowers also make it possible to clean large areas more thoroughly, in an easy way. During cleaning of an area with conventional equipment, obstructions such as cars parked in parking spaces can make it necessary to leave parts of the area uncleaned. However, if the same area is cleaned with a leaf blower it is possible to blow away the rubbish underneath the parked cars, which will increase efficiency, save time and improve results. Some leaf blowers can also include a vacuum feature in which the direction of air flow is reversed and leaves and other objects are drawn by the leaf blower into a receiving bag.

Even though the leaf blower is an effective tool that helps the operator to clean large areas, many leaf blowers available on the market today are large and heavy with a center of gravity located at a long distance from the operator. Blowers also generate substantial vibration and noise which makes their use very tiring and/or uncomfortable for the operator and for other persons located close to the tool.

In addition to problems with noise and vibration, there may be air leakage between two scrolls of a blower allowing for air to escape causing a decrease in efficiency of the blower. The attachment points are often secured together via screws, which, in addition to causing air leakage, increases blower weight and manufacturing costs. Also, because the blower is secured only at a series of points, locations along the blower joint without screws suffer from decreased structural rigidity because there may be nothing to secure the joint at locations without attachment points. This decreased structural rigidity is a detriment because if the blower is dropped, it is more likely to break apart and cause injury to the user or others nearby. Thus, there has been a need for an improved blower seal resulting in better performance, decreased cost, less vibration, and improved safety. The present disclosure meets this need.

### BRIEF DESCRIPTION OF THE DRAWINGS

Embodiments of the present application will now be described, by way of example only, with reference to the accompanying drawings, wherein:

FIG. 1 is an illustrative blowing apparatus, with attached engine housing, having fused upper and lower scrolls in accordance with an embodiment of the present disclosure;

FIG. 2 is an illustrative blowing apparatus, without an attached engine housing, having fused upper and lower scrolls in accordance with an embodiment of the present disclosure;

FIG. 3 is a bottom view of the assembly of FIG. 2;

FIG. 4 is a side view of the assembly of FIG. 2;

FIG. 5 is an illustrative upper scroll positioned above a lower scroll prior to being fused in accordance with one embodiment of the present disclosure;

FIG. 6 is an illustrative representation of a lower scroll in accordance with one embodiment of the present disclosure;

FIG. 7 is an illustrative representation of an upper scroll in accordance with one embodiment of the present disclosure; and

FIG. 8 is an illustrative cross sectional view of a weld joint in accordance with an embodiment of the present disclosure.

### DESCRIPTION OF EXAMPLE EMBODIMENTS

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating like elements.

FIG. 1 illustrates one example configured according to the present disclosure. FIG. 1 illustrates a leaf blower 100 or blower/vac (e.g., a blower convertible into a vacuum). While the disclosure focuses on a leaf blower 100, one of ordinary skill in the art would appreciate that it equally applies to other blower and blower/vac devices designed to blow forced air or intake air through an air intake, respectively. As shown, the leaf blower 100 includes an engine housing 14 operatively coupled to an impeller (not shown) that is configured for rotational motion within a scroll housing 110, formed by upper scroll 11 and lower scroll 10 joined at joint 15, and which will be described in greater detail below. Various power drive units can be utilized, such as electric motors or internal combustion engines (e.g., 2 stroke or 4 stroke engines). When in the blowing operation mode, the scroll housing 110 generally defines an air inlet for accepting air, covered by inlet cover 12, and an air outlet 16 for dispensing the air at an increased speed and/or pressure. Conversely, when the blower is equipped with a vacuum feature, the opening described as an air inlet becomes the air outlet and the air outlet 16 becomes the air inlet. In the vacuum mode, the blower/vac may have additional components which are designed to capture the matter vacuumed up by the blower/vac. Various tube attachments, collection bags, or other components may be respectively coupled to the air inlet and/or outlet to accommodate use of the blower in either a blowing or vacuuming application. The scroll housing 110 is configured in a centrifugal fan arrangement, though it could also be configured in an axial arrangement or the like.

The leaf blower 100 also includes a handle 13 for carrying and pointing/directing the blower 100. The handle 13 is intended to be a representative example, and can include various other sizes, geometries, and/or features. In one example, the handle 13 may be formed separately and attached to the housing 14 or various other components of the blower 100. For example, as shown, the handle 13 can be coupled to a portion of the engine housing 14. The handle 13 can be coupled to the engine housing 14 in various ways, including with fasteners (e.g., screws, bolts, etc.), snap/click fastening arrangements, press fit, interference fit, adhesives, welding, and/or various other removable or non-removable fastening arrangements, and/or combinations thereof. In another embodiment, the handle 13 may be fixed to the scroll housing. Alternatively, the handle 13 may be formed as an integral component of housing 14. Additionally, the handle 13 may have a different shape or configuration, such as being fixed at two or more points rather than the cantilevered configuration with one attached end and one free end as illustrated.

In addition or alternatively, an isolator may be utilized between the handle 13 and the remainder of the blower to help control the transmission of vibration from the power drive unit and/or impeller to the user. In one example, the vibration isolator may be placed between the handle 13 and the engine housing 14. For example, the vibration isolator can include a sleeve (e.g., a “rubber grommet” style sleeve or the like) that is installed on the handle 13, and then inserted snugly into the engine housing 14 housing during installation of the handle 13. Thus, the vibration isolator can inhibit or even prevent vibrations from being transmitted to the user through the handle 13.

In addition, the fastening of the handle arrangement 13 can be performed by the manufacturer, or alternatively, can be performed by an end user. In one example, to reduce carton size during the shipping and retail phase, the blower handle 13 can be a separate part provided in the carton and intended for installation by the end user. The consumer could press the handle 13 into the engine housing 14 and secure it using any of the methods mentioned above, including by way of a fastener or the like. Likewise, if the handle 13 is designed to be attached in one of the other locations as described above, the consumer could affix the handle in the predetermined location.

In addition or alternatively, the blower 100 can be configured with a compact design to reduce the carton size during transport and/or retail sales. The total length and/or height of the blower 100 can be reduced such that the unassembled blower 100 will fit more readily inside of a relatively smaller sized carton. In one example, the total length (X) of the blower 100 can be divided approximately in half, though various other ratios are also contemplated. For example, the length (X2) of the blower tube 20 can be approximately equal to the overall length (X1) of the scroll housing 110, though the elements can be permitted to overlap to some extent so as to provide an acceptable connection and/or sealing arrangement therebetween. The blower tube 20 can be coupled to the scroll housing 110 in various removable manners, including fasteners (e.g., screws, bolts, etc.), snap/click fastening arrangements, press fit, interference fits, adhesives, and/or various other removable fastening arrangements. Thus, the length of the carton size can be relatively reduced by approximately half, and the blower tube 20 can be assembled to the scroll housing 110 by the end user before use. Of course, the blower tube 20 can also be subsequently removed from the scroll housing 110 to provide for a more compact storage arrangement.

In addition or alternatively, as described herein, the handle 13 can be provided in the carton as a separated component from the blower 100. When the blower 100 is shipped with the handle 13 detached, the height of the carton size can be relatively reduced by the extent to which the handle extends thereabove (e.g., above the uppermost portion, such as the power drive unit). As illustrated, the height of the blower 100 with the handle attached is Y. If the handle is removed, the height is reduced to Y1.

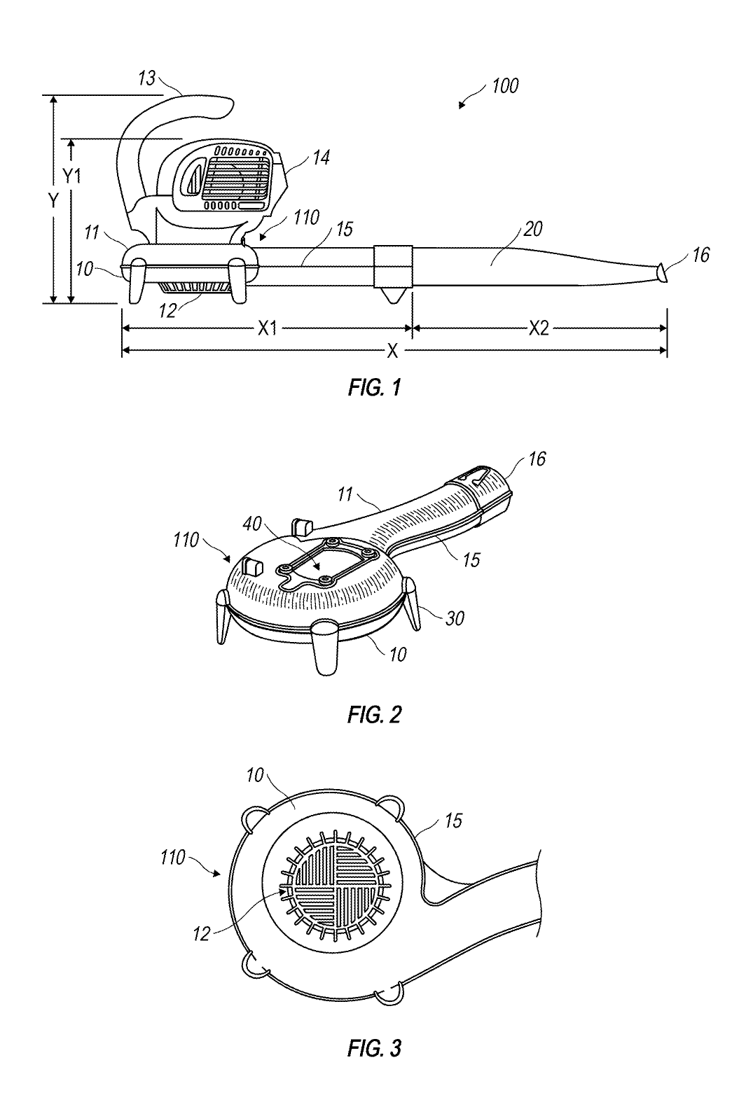

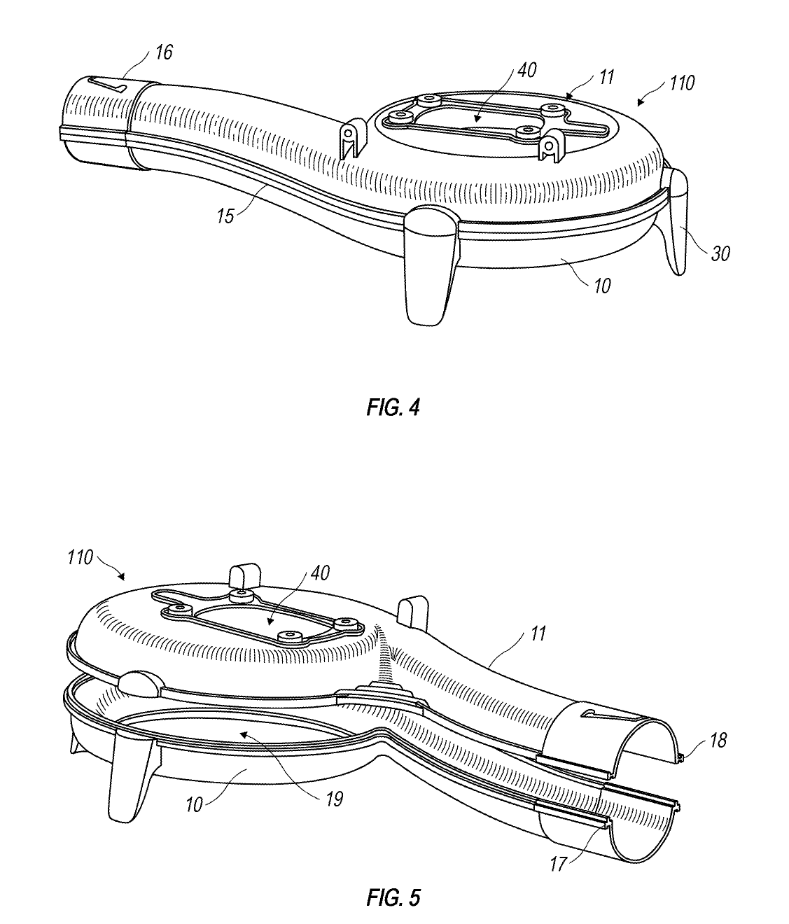

An exemplary top perspective view of the scroll housing 110 is illustrated in FIGS. 2 and 4. The scroll housing 110, as illustrated, can be formed into one piece by welding shell-halves together using one of the techniques described herein. As shown, the scroll housing 110 has an opening in the upper scroll 11 which allows for transmission of driving power from the engine (not shown) to an impeller located within the scroll housing 110. Additionally, a gasket or seal can be created between the engine housing 14 and the opening. In at least one embodiment, the engine is connect to the housing with at least one fastener (e.g., screw, bolt, etc.), snap/click fastening arrangements, press fit, interference fits, adhesives, welding, and/or various other removable or non-removable fastening arrangements, and/or combinations thereof. The lower scroll 10 can have feet 30 attached thereto to support the blower 100 when it is placed on the ground. Additionally this can assist in preventing the air inlet cover 12 (illustrated in FIGS. 1 and 3) from being blocked when the engine and impeller are running

A bottom view of the scroll housing 110 is illustrated in FIG. 3. The air inlet cover 12 is located on the lower scroll 10. The air inlet cover 12 can have openings that are designed to allow air flow but prevent debris exceeding certain sizes from entering the air intake of the scroll housing 110. While a particular pattern and arrangement of these openings are illustrated, those skilled in the art will appreciate that other openings can be used as well. The inlet cover can be formed as part of the lower scroll 10 or it can be made separately and fixedly or removably attached.

The above described scroll housing 110 can be provided as a single or multiple piece shell. For example, the scroll housing can be provided as a single, unitary shell by various manufacturing processes, such as injection molding, blow molding, rotational molding, etc. In another example, the scroll housing 110 can be provided as a multiple piece shell, such as a two piece scroll as shown in FIG. 5. The upper scroll shell 11 and lower scroll shell 10 can be manufactured separately using various manufacturing processes, including injection molding, blow molding, rotational molding, etc., though various other processes are also contemplated. Once the upper scroll 11 and lower scroll 10 are formed, they can be coupled in various manners, including fasteners, adhesives, welding, etc.

In one example, as shown more fully in FIG. 5, the upper scroll 11 and lower scroll 10 can be coupled by way of a welding operation, such as vibration or friction welding or the like. For example, the upper scroll 11 and lower scroll 10 can be vibration welded together along the scroll perimeter, and/or along an extension tube portion coupled thereto. Thus, the perimeter of the lower scroll 10 can include a projection or ridge 17. While the upper scroll 11 can include a corresponding pocket, trough or channel 18. The upper scroll 11 and lower scroll 10 can then each be placed into a suitable vibration/friction welding mold, whereupon the upper scroll 11 and lower scroll 10 can be mated together such that the projection 17 mates with the pocket 10, and are subsequently fused together. Of course, the projections 17 and channel 18 can be oppositely arranged on the upper scroll 11 and lower scroll 10, respectively, as well.

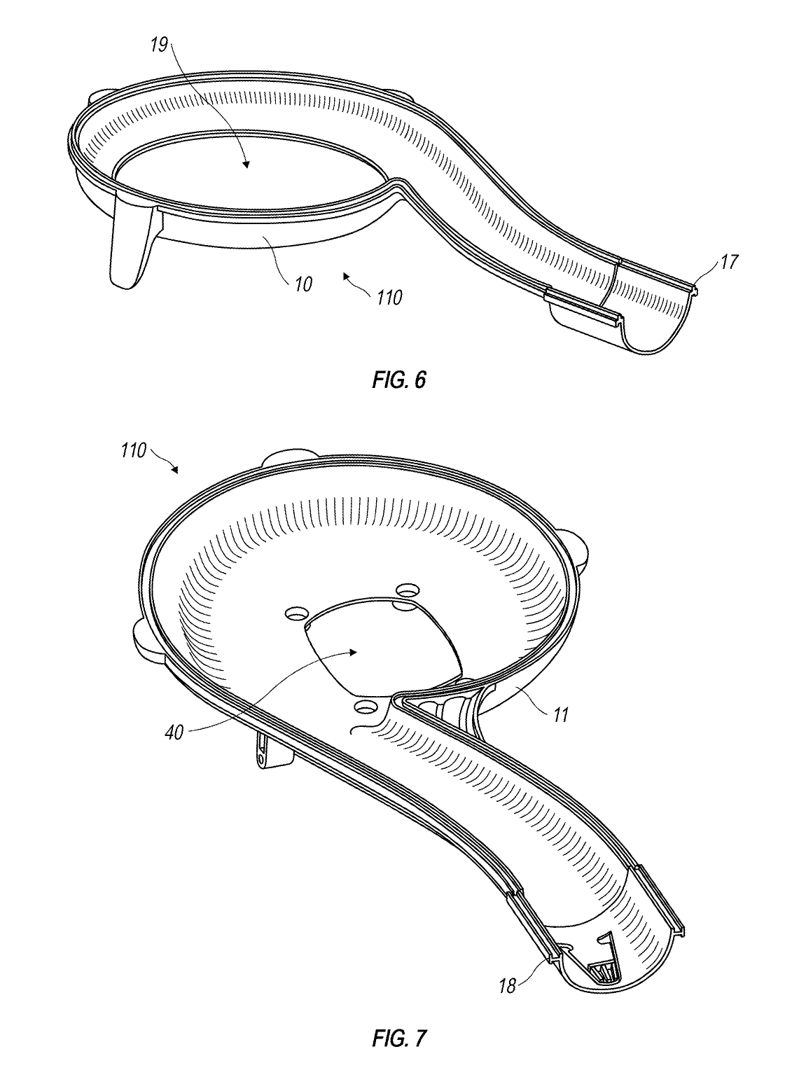

The projection 17 and the pocket 18 are more clearly illustrated in FIGS. 6 respectively. FIG. 6 illustrates the lower scroll 10. Projection 17 is illustrated running the entire perimeter of lower scroll 10. Inlet 19 is formed in the lower scroll 10. FIG. 7 depicts an upper scroll 11. Pocket or channel 18 is illustrated running the entire perimeter of upper scroll 11. While in the illustrated examples the projection 17 and pocket 18 have a particular geometry, other geometries are contemplated as being within the scope of the disclosure. As illustrated, the geometry of the mating channel 19 and ridge 17 is substantially rectilinear in nature. In other examples, the projection 17 can be shaped to resemble a triangle, a semi-circle or other geometry. The pocket 18 could likewise be formed to complimentarily receive the projection 17 to form the joint 15.

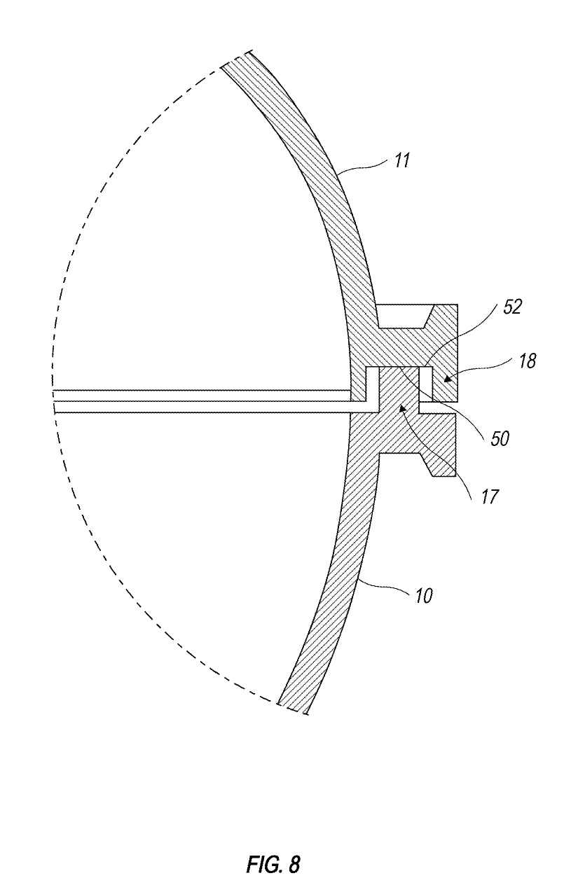

A close up of a mated pocket 18 and projection 17 is illustrated in FIG. 8. As illustrated there is a gap between the projection 17 and the sides of the pocket 18. When the projection 17 is welded to the pocket 18, the top surface 50 of the projection 17 is welded to the bottom surface 52 of the pocket 18. In other geometries more than one side of the projection 17 can be welded to the pocket 18.

The vibration/friction welding can be performed at various times in the manufacturing process. In one example, the vibration/friction welding can be performed relatively early in the manufacturing process when the upper scroll 11 and the lower scroll 10 are still warm/semi-hot and/or soft from their respective molding operations (e.g., at a relatively short time after forming each half). Thus, when the relatively warm/soft upper scroll 11 and the lower scroll 10 are placed into the fixed vibration/friction welding mold, the upper scroll 11 and the lower scroll 10 are welded together in a relatively accurate environment (e.g., provided by the fixed mold geometry) that can inhibit or prevent warping, defects, or the like that can otherwise compromise the seal between the upper scroll 11 and the lower scroll 10. As such, the fixed vibration/friction welding mold can help maintain tolerances of the scroll housing 110.

It can be beneficial to weld the upper scroll 11 and the lower scroll 10, as opposed to coupling via fasteners or adhesives, because a relatively higher quality, lower weight, and increased performance scroll housing can be achieved. In one example, the weight, parts, and labor associated with the fasteners or adhesive can be reduced or eliminated. Further, labor costs can be saved because less time is wasted trying to assemble warped parts. In another example, quality can be improved as the vibrational welding technique can reduce or avoid warping and/or provide fewer defects. Moreover, a weld joint 15, running along the entire perimeter, can be the strongest portion of the scroll to provide increased structural integrity. In another example, a substantially complete seal is provided between the upper scroll 11 and the lower scroll 10 by welding which establishes a hermetic seal that inhibits air leakage from the scroll housing 110 around the scroll perimeter during use of the blower 100. As such, fewer or even no additional seals are required between the upper scroll 11 and the lower scroll 10. Still, it is to be appreciated that one or more additional seals may be used between the upper scroll 11 and the lower scroll 10. Moreover, the welding can improve necessary tolerances to maintain a secure connection between the scroll outlet and the tube.

Other variations of the shape of the pocket and protrusion, as discussed above, are contemplated in embodiments of the present disclosure for joining surfaces of the first and second scroll halves. The scroll housing halves may be shaped in a manner such that the surface of the perimeter of one scroll housing half is the mirror image of the surface of the perimeter of the other scroll housing half. For example, a first scroll housing half may have one or more protrusions, forming a non-planar surface such as a flange, protruding from the first scroll housing half. A second scroll housing half may have on its perimeter one or more channels to mate with the protrusions of the first scroll housing half and thereby forming a mirror image of the one or more protrusions of the first scroll housing half such that the perimeters of the two scroll housing halves are flush against each other when joined. When fused or welded together, the joint described in this embodiment forms a continuous bond achieving even greater relative quality and performance due to increased rigidity, a stronger bond and a more efficient hermetic seal.

When assembling a blower according to the above disclosure, the engine and housing 14 can be installed once the scroll housing 110 has been welded together. With the engine or motor installed, the impeller can now be installed. Because the scroll housing halves have been previously coupled, an inlet opening 19, as shown in FIGS. 5 and 6, can be provided in the lower scroll housing 10 for installing the impeller therethrough. For example, the scroll housing 10 can include a relatively large inlet opening to permit the impeller to be coupled to the driveshaft of the engine or motor. An inlet cover 12, as illustrated in FIGS. 1 and 3, can then be used to cover the bottom surface to provide protection against the impeller during use. Because the impeller operates as a centrifugal blower, air is “thrown” towards the outside of the impeller and against the interior walls of the scroll housing. However, because the inlet opening 19 does not lie in this position (e.g., the opening lies in a perpendicular plane to the air force vector), a less dense material can be used for the inlet cover 12 to save additional weight and/or cost, without compromising performance and/or safety. Still, various other methods of coupling the impeller to the engine or motor output are also contemplated.

While the above has been described in relation to an upper scroll housing and lower scroll housing, these portions can also be referred to a first and a second scroll housing. Additionally, the geometry of the joint 15 of the upper scroll housing 11 and lower scroll housing 10 can be reversed such that the geometry described above in relation to the upper scroll housing 11 could be positioned on the lower scroll housing 10 and vice versa such that the mating profiles are still present.

While described generally herein with reference to a handheld blower or blower/vac, it is to be appreciated that various other types of blowers can also be used, including back-pack style blowers, wheeled blowers, and the like. The blower has been described with reference to the example embodiments described above. Modifications and alterations will occur to others upon a reading and understanding of this specification. Example embodiments incorporating one or more aspects of the disclosure are intended to include all such modifications and alterations.

1.-17. (canceled)

18. A method of manufacturing a housing for a blowing apparatus, comprising:
providing a first scroll having a perimeter therearound with a pocket formed therein;
providing a second scroll having a perimeter therearound with a projection formed therein;
coupling the first scroll and the second scroll together by forming a joint in which the projection of the second scroll fits within the pocket of the first scroll and then the joint is welded together.

19. The method of claim 18, wherein said joint is continuous such that air does not flow through said joint.

20. The method of claim 18, wherein said joint forms a ridged connection between the first scroll and the second scroll.

21. The method of claim 1, wherein said welding is friction welding.

22. The method of claim 1, wherein said welding is vibration welding.

23. The method of claim 1, further comprising providing an opening through which installation of an impeller is accommodated into the welded together first scroll and second scroll.

24. The method of claim 23, further comprising inserting an impeller through said opening into the welded together first scroll and second scroll.

25. The method of claim 24, further comprising covering said opening with an inlet cover fixedly attached to said second scroll.

26. A blowing apparatus, comprising:
a scroll housing comprising:
a first scroll half having a first perimeter, the first perimeter having a channel formed thereupon;
a second scroll half having a second perimeter, the second perimeter having a protrusion extending therefrom, said protrusion of the second scroll perimeter being inserted into and mated with the channel of the first perimeter and the first scroll half and second scroll half being welded together along the mated perimeters of the halves and thereby forming a secured joint therebetween and thereby establishing the scroll housing.

27. The blower apparatus of claim 26, wherein said welding is friction welding.

28. The blower apparatus of claim 26, wherein said welding is vibration welding.

29. The blower apparatus of any one of claims 26, wherein said joint is continuous such that air does not flow through said joint.

30. The blower apparatus of any one of claims 26, wherein said joint forms a ridged connection between the first scroll half and the second scroll half.

31. The blowing apparatus of any one of claims 26, further comprising an impeller, wherein the impeller is positioned within the welded scroll housing.

32. The blowing apparatus of any one of claims 26, further comprising an inlet formed in at least one of said first scroll half and said second scroll half.

33. The blowing apparatus of claim 32, further comprising an inlet cover attached to the one of the first scroll half and second scroll half comprising the inlet.

34. The blowing apparatus of claim 33, further comprising an engine housing secured to the other of the first scroll half and the second scroll half opposite the scroll half comprising the inlet.
